(19) United States
(12) Patent Application Publication
(10) Pub. No.: US 2024/0149210 A1
(43) Pub. Date: May 9, 2024

(54) COMBINATION CARBON MONOXIDE AND NITROGEN DIOXIDE SCRUBBER TREATMENT AND PROCESS

(71) Applicant: Stephen M. Mosher, Chandler, AZ (US)

(72) Inventor: Stephen M. Mosher, Chandler, AZ (US)

(21) Appl. No.: 18/388,142

(22) Filed: Nov. 8, 2023

Related U.S. Application Data
(60) Provisional application No. 63/424,016, filed on Nov. 9, 2022.

(51) Int. Cl. B01D 53/14; B01D 53/18; B01D 53/34; B01D 53/56; B01D 53/62; B01D 53/78; C02F 1/50

(52) U.S. Cl. CPC B01D 53/1456; B01D 53/1412; B01D 53/1493; B01D 53/185; B01D 53/346; B01D 53/56; B01D 53/62; B01D 53/78; C02F 1/505; B01D 2251/21; B01D 2252/103; B01D 2257/404; B01D 2257/502; C02F 2103/18; C02F 2303/04

(57) ABSTRACT

A scrubber system configured to react gas phase nitrogen dioxide and carbon monoxide emissions from process applications in scrubber tower equipment with the use of reducing agent chemistry combined with copper silver ionization.

### CROSS-REFERENCE TO RELATED APPLICATION

This application claims the benefit of U.S. Provisional Application No. 63/424,016 filed Nov. 9, 2022, the entire contents of which are hereby incorporated by reference.

### BACKGROUND

Nitrogen Oxide emissions are a family of nitrogen-based compounds that can react in the ozone to form harmful and undesirable compounds in the environment. This family of compounds are referred to as NOx compounds.

There are government regulated limitations for NOx emissions and thus process systems that produce NOx compounds must be treated to prevent release into the environment. The most commonly produced NOx compounds from hydrocarbon burn processes are nitric oxide (NO) and nitrogen dioxide (NO₂). When treating for NOx, NO can be converted to NO₂ through various oxidation chemical reactions, where NO₂ is in a form that is more soluble than NO. While nitrogen dioxide (NO₂) is partially soluble in water, it is still a challenging compound to completely remove without a chemical reducing agent chemistry to assist in the complete removal from the air or gas stream.

NOx compounds are created from hydrocarbon burn processes which also produce carbon monoxide as a byproduct of the reaction. CO is also considered a regulated environmental pollutant and therefore must be treated accordingly to comply with government regulations.

### BRIEF DESCRIPTION OF THE DRAWINGS

Features and advantages of the disclosure will readily be appreciated by persons skilled in the art from the following detailed description when read in conjunction with the drawing wherein:

FIG. 1 illustrates an exemplary embodiment of a nitrogen dioxide treatment scrubber system.

FIG. 2 illustrates an exemplary alternate embodiment of a nitrogen dioxide treatment scrubber system.

### DETAILED DESCRIPTION

In the following detailed description and in the several figures of the drawing, like elements are identified with like reference numerals. The figures are not to scale, and relative feature sizes may be exaggerated for illustrative purposes.

To react nitrogen dioxide to a form acceptable for release to the atmosphere or environment, traditional reducing agents are based on elemental sulfur compounds such as sodium sulfide, sodium sulfite, or sodium bisulfite as examples. These reducing agents are highly effective at breaking down nitrogen dioxide to nitrogen gas, sodium sulfate, sodium nitrite, and sodium nitrate. However, sulfur-based compounds when over-fed, i.e., dosed at a concentration ratio of more than 5 ppm of sulfur compound per 1 ppm of nitrogen dioxide compound, or are highly concentrated, can form harmful acid gases, specifically hydrogen sulfide which is also a regulated emission.

In an effort to create a safer reducing agent solution that eliminates the potential for hydrogen sulfide gas, other reducing agents are capable of accomplishing the same task while being safer to handle, and more effective in the reducing process. One such group of chemicals includes ascorbic acid-based chemicals (including but not limited to): mono-dehydroascorbic acid, sodium ascorbate/erythorbate, and ammonium ascorbate/erythorbate. These chemicals when applied in a controlled manner have a stronger redox (reduction-oxidation) capability unique to NO₂ compounds thus making them more efficient at reducing nitrogen dioxide levels. These chemical compounds provide greater NO₂ absorption treatment effectiveness in standard single stage scrubber systems utilizing standard scrubber packing height (typically six feet to eight feet in depth) as well as standard pH control parameters (operating pH of 8-10)—thus not requiring added chemicals or modifications to existing or standard scrubber system designs. Further, these compounds will not form harmful hydrogen sulfide gas. Ascorbic acid compounds also have a strong propensity to reduce copper oxide compounds into a form that has proven effective for treating carbon monoxide emissions in scrubber equipment. The combined application of ascorbic acid-based compounds and chemical application control equipment to treat NO₂ and CO emissions is thus a novel process.

Alternatives to the ascorbic acid compounds disclosed above include sodium thiosulfate, thiourea (99%), 2.4-pentanedione (99%), 2.3-pentanedione (97%), bar-bituric acid (99%), oxalic acid (98%), glyoxal (40 wt %), and di(ethline glocal) (99%). The following description of exemplary embodiments of a system and process utilizes ascorbic acid reducing agents. It is to be understood that the alternate reducing agents may be utilized in the system and process in place of the ascorbic acid compounds.

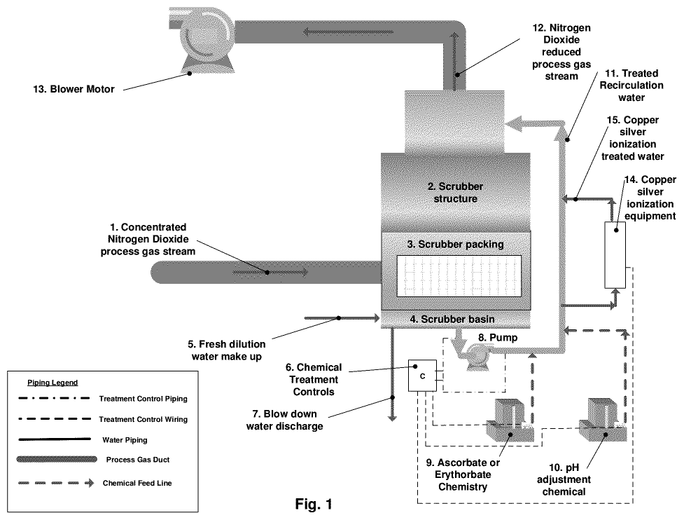

The absorption reaction process between NO₂ (as well as other compounds) and aqueous ascorbate/erythorbate chemistry is complex and is dependent upon multiple diffusion and chemical reaction process steps until completion. In general, the first step is a diffusion step where NO₂ is partially diffused through a liquid-gas phase medium in the scrubber solution where a portion of the NO₂ (gas)<->NO₂ (Aqueous) occurs. This first step occurs in the scrubber 2 in FIG. 1.

The next steps of the process include complex chemical reactions between ascorbate/erythorbate, water, oxygen, and the aqueous NO₂ and other metals such as copper or iron. These chemical reactions can occur very rapidly. Ascorbic acid will react with dissolved oxygen in water to partially oxidize the ascorbate/erythorbate compounds while at the same time reacting with NO₂ and copper-based compounds in the process. The reaction between ascorbic acid and copper oxide produces Cuprite (Cu₂O) which reacts with carbon monoxide reacting it to form CO₂ and elemental copper thus reducing carbon monoxide emissions. As such the combined process chemistry of ascorbic acid and copper silver ionization, when applied in traditional water scrubbing equipment can be utilized to simultaneously react and absorb nitrogen dioxide and carbon monoxide emissions from process gas waste streams.

In accordance with an aspect of the invention, there is a chemical reaction that takes place that changes the “form” of copper (as CuO) to the proper chemical form of copper (Cu₂O) that reacts with Carbon monoxide.

C₆H₇NaO₆+2CuO->C₆H₆O₆+Cu₂O+NaOH

Cu₂O+CO->2Cu+CO₂

FIG. 1 illustrates an exemplary embodiment of a Nitrogen Dioxide treatment scrubber system 50. The elements of the system are described as follows.

Concentrated Nitrogen Dioxide Process Gas Stream 1. This stream is untreated, highly concentrated nitrogen dioxide process gas stream coming from the NOx producing process source equipment. This stream is the input to the scrubber system 50. Examples of the NOx producing source equipment include, for example, industrial boilers, semiconductor vacuum abatement equipment, industrial metals manufacturing processes that utilize heat treating, and water spray/scrubber tower equipment.

Scrubber Structure Equipment 2. This is the scrubber equipment designed to absorb water soluble gases from the process gas stream 1.

Scrubber Packing Media 3. The scrubber packing material is designed to increase water surface area so that water soluble gases are more easily “scrubbed” from the process gas stream. Suitable materials include, for example, ceramic structured packing, thermoplastic scrubber packing including polypropylene, NSF polypropylene, polypropylene with glass, Polyvinylchloride, CPVC, PVDF, Tefzel, and metal packing including stainless steel, Hastelloy, and Inconel.

Scrubber Basin 4. This is the portion of the scrubber equipment that contains a water reservoir for recirculation over the scrubber packing.

Fresh Dilution Make-Up water 5. Fresh dilution make-up water to the scrubber system is provided to minimize dissolved mineral content and avoid buildup of “scrubbed” compounds.

Chemical Treatment Controls 6. The chemical treatment control system 6 is used to optimize pH control and control dosage of erythorbate or ascorbate-based chemistry which is designed to react with a nitrogen dioxide based chemical treatment (9). The control system is an electronic controller, which typically will be a programmable logic controller (PLC) or a microprocessor-based system or set of controllers.

Blow-Down Water Discharge 7. The blow-down water discharge serves to remove concentrated or over saturated mineral content recirculation water so that fresh water make up can replenish higher concentrated water.

Recirculation Water Pump 8. The recirculation pump is utilized to pull water from the scrubber basin reservoir and recirculate the water over the scrubber packing (3) and back to the scrubber basin. The recirculation pump 8 is controlled by chemical treatment controls 6.

Ascorbate or Erythorbate Based Chemistry 9. This refers to ascorbate or erythorbate based reducing agent chemistry stored in a tank or vessel. The chemistry is designed to react with nitrogen dioxide molecules in the gas stream and recirculation water. Item 9 includes the chemistry, the vessel and a chemistry pump under control of the control system 6 to pump the reducing agent chemistry into the recirculation water output from the pump 8.

pH Adjustment Chemistry 10. The pH adjustment chemistry such as sodium hydroxide, sodium carbonate, hydrochloric acid, or sulfuric acid is stored in a tank or vessel, and is utilized to optimize scrubber recirculation water pH. Item 10 includes the chemistry, the vessel and a pH adjustment pump under control of the control system 6 to pump the pH adjustment chemistry into the recirculation water output from the pump 8.

Treated Recirculation Water 11. This treated recirculation water stream is water is recirculated over the scrubber packing fill (3) and back to the scrubber basin, treated with ascorbate or erythorbate based chemistry to react with nitrogen dioxide compounds. Treated water 11 is the combination of the scrubber water with treatment chemicals, e.g. water combined with sodium ascorbate as an example.

Treated Gas Stream Effluent (With Reduced Nitrogen Dioxide Concentration) 12. This is the treated gas stream containing a reduced concentration of nitrogen dioxide compounds. This effluent 11 is the output gas from the system.

Blower Motor 13. The blower motor is used for drawing air or process gas stream through the exhaust ductwork and through the scrubber system and to the environment.

Copper Silver Ionization 14. The copper silver ionization system is used to produce copper and silver ions for microbiological disinfection and copper conversion to Cuprite for carbon monoxide reduction Copper silver ionization is an electrochemical reaction process that reacts elemental copper and silver into an appropriate form for use soluble in water. Copper silver ionization systems are known, and commercially available, e.g. Liquitech, https://www.liquitech.com/products/copper-silver-ionization/. The equipment 14 is controlled by chemical treatment control system 6.

Copper Silver Ionization Treated Water 15. This is water treated with copper silver ionization from system 14 for microbiological disinfection purposes as well as adding copper for oxidation for carbon monoxide reduction. The copper silver ionization treated water 15 is combined with the treated recirculation water 11 for recirculation through the scrubber 2.

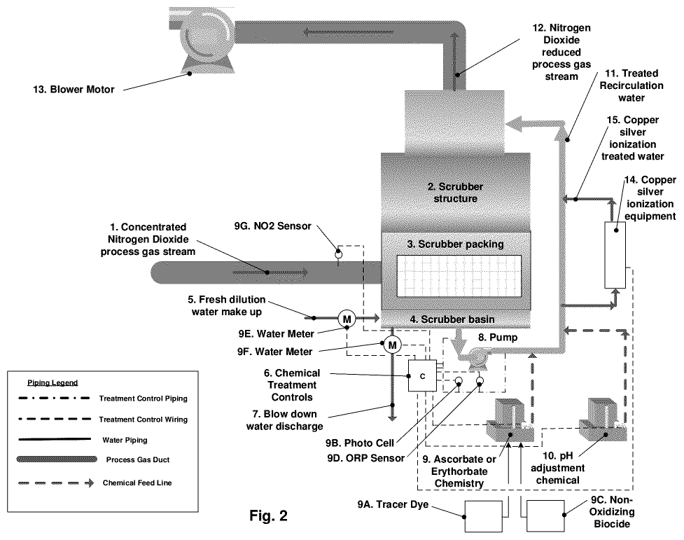

FIG. 2 illustrates an exemplary embodiment of a Nitrogen Dioxide treatment scrubber system 50′. The system 50′ is similar to that of FIG. 1, with like reference numbers designating like elements. The system 50′ has additional features.

These features include two flow meters, one (9E) on the make-up line 5 and another (9F) on the blow-down line 7. The flow meters are electrically connected to the chemical treatment controls 6, which is configured to allow automated control of the chemical feed of the sodium ascorbate into the scrubber.

In an exemplary embodiment, the sodium ascorbate chemistry 9 is applied by taking a proportional signal from the make-up meter 9E and sending that signal into the control system 6. The control system 6 sends a proportional signal to the pump of chemistry 9 to feed a ratio of sodium ascorbate to feed proportionally to make up water flow.

In an alternate embodiment, the sodium ascorbate chemistry 9 can be applied by taking a proportional signal from the blow-down sensor 9F of the scrubber, and sending that signal to the control system 6. The control system 6 uses the sensor 9F signal to calculate a proportional signal sent to the ascorbate 9 to feed in relation to the blow-down of the scrubber.

The embodiment of FIG. 2 also includes an NO₂ sensor 9G, which measures the NO₂ level in the incoming air duct stream 1. The sensor output signal is fed to the control system 6.

In an exemplary embodiment, copper silver ionization is controlled via the control system 6 by taking in an input signal from the make-up water meter 9E and feeding a proportional signal to the copper silver ionization equipment 15 to proportionately feed copper and silver with the make-up rate in a ratio basis. For example, for every 1000 gallons of water, 0.1 ppm of copper and silver is produced and dosed into the system.

Another optional feature is the provision of an inert tracer dye 9A, configured to be blended with the ascorbate/erythrobate chemistry 9. The tracer dye 9A is used in combination with a photocell analyzer 9B to control the chemistry application in a controlled process such that nitrogen dioxide reduction is efficiently reduced to an environmentally acceptable compound or molecule. In an exemplary embodiment, the tracer dye is a fluorescent tracer dye. An exemplary tracer dye is PTSA Tracing Dye CAS NO. 59572-10-0 available from Kunshan Haite Plastic Pigment Co., Ltd, Jiangsu, China. An exemplary photocell analyzer suitable for the purpose is the Little Dipper™ 2 In-line Fluorometer, Walchem, Iwaki America Inc., Holliston, MA.

An alternate control method is to use the photo cell analyzer 9B that sends a ultraviolet light wave through the water solution via the bypass flow stream (between the pump discharge and suction side (FIG. 2) and picks up a direct measurement of the tracer dye element by UV absorption and sends that signal into the control system 6. the control system uses that signal in a calculation of the amount of chemical in the water, then activates the ascorbate chemistry pump (9) based on a set point level predetermined in the control system 6. The controller may, for example, operate the chemical pump based on a proportional integral derivative (PID) control algorithm and setpoint to ensure that the exact correct amount of chemical is in the system at all times based on a measurement (from sensor 9F) of the NO₂ level in the incoming air duct stream. This input NO₂ signal level goes into a calculation in the control system 6 as to how much chemical is needed in the scrubber, and the control system 6 makes the calculation automatically, then adjusts the pumping rate and dosage accordingly to ensure the precise amount of chemical is applied for ideal control. In an exemplary embodiment, the control system 6 also controls the pH as well as the ionization system.

Another feature of system 50′ is the use of non-oxidizing disinfecting chemical treatment 9C blended with the sodium erythorbate/ascorbate reducing agent. Examples of non-oxidizing biocide include Glutaraldehyde, Tetrakis Hydroxymethyl phosphonium sulfate, Isothiazolin, Tributyl tetradecyl phosphonium chloride, 2,2-dibromo-3-nitrilopropionamide.

As far as the blending of the tracer element dye 9A and the non-oxidizing biocide chemistry 9C with sodium ascorbate 9, this is typically done in a manufacturing facility where the chemicals are blended together in a predetermined proprietary ratio of each ingredient. The process typically involves first adding the primary ingredient (sodium ascorbate family of chemicals) and completely dissolving this into deionized water with thorough mixing for a set period of time of time. Then the tracer element dye is added and thoroughly mixed at the proper concentration. Then lastly, the non-oxidizing biocide would be mixed at the proper ratio to other active ingredients. Once all materials are properly mixed, stability testing is done across a wide range of temperature and pH conditions to ensure all ingredients remain in solution and do not precipitate out. Once the stability is confirmed, the products are packaged into various sized containers and are available for shipping to the point of application use.

Another feature of system 50′ is an oxidation reduction potential (ORP) control sensor 9D. The control system 6 receives the ORP sensor signal, and is configured to apply the ascorbic acid chemistry 9 in a controlled manner. Exemplary ORP sensors include the WEL Series Electrodes available from Walchem.

For ORP control of sodium ascorbate, the sodium ascorbate (and family of chemistry) is a reducing agent and will reduce oxidation reduction potential of the water stream it is applied into. The ORP sensor 9D will measure the ORP level in millivolt units. As the sodium ascorbate is dosed into the recirculation water, this millivolt level will decrease in a “falling setpoint” since the levels will reduce as the more chemical is applied. The sodium ascorbate can be dosed, under control of the control system 6, to a “falling setpoint” range to maintain the sodium ascorbate concentration based on the millivolt level in the water stream where the ORP level (in my) is correlated to a certain concentration of sodium ascorbate. This mechanism is an indirect control measurement of sodium ascorbate dosing, but it can be used to correlate dosing to “demand” for the ascorbate versus simply applying the chemistry in a proportional feed method as discussed above in the make-up and blow-down proportional flow methods.

The ORP 9D sensor will typically be located in a bypass flow stream which is typically a 1″ PVC piping that takes high pressure water off the discharge of the scrubber recirculating pump and then returns this bypass line into the suction side of the scrubber recirculating pump, this giving a smaller flow stream but representative concentration of the concentration in the scrubber water. This is done because it is easier to service the sensor in a bypass loop configuration as opposed to having a sensor located directly in the large, full size scrubber water recirculation piping line.

Although the foregoing has been a description and illustration of specific embodiments of the subject matter, various modifications and changes thereto can be made by persons skilled in the art without departing from the scope and spirit of the invention.

What is claimed is:

1. A scrubber system configured to react an incoming process gas stream having nitrogen dioxide and carbon monoxide emissions from process applications with the use of reducing agent chemistry combined with copper silver ionization, comprising:
a scrubber having an input port for receiving the process gas stream, the scrubber configured to absorb water soluble gases from the process gas stream;
the scrubber including a scrubber packing material configured to increase water surface area;
the scrubber defining a basin with a water reservoir for recirculation over the scrubber packing;
a recirculation pump for pumping water and chemical solution from the scrubber basin through a recirculation path;
reducing agent chemistry stored in a tank or vessel;
a dosing system comprising a chemical treatment controller and a chemistry pump configured to pump the reducing agent chemistry into the recirculation path; and
copper silver ionization equipment configured to dispense copper silver ionization treated water into the recirculation path.

2. The system of claim 1 wherein the reducing agent chemistry is ascorbic acid chemistry including one or more of sodium ascorbate/erythrobate, ammonium ascorbate/erythorbate, or mono-Dehydroascorbic acid used as a reducing agent to absorb nitrogen dioxide to reduce nitrogen-based emissions.

3. The system of claim 1, wherein the reducing agent-based chemistry is applied in water spray/scrubber tower equipment.

4. The system of claim 1, wherein the system includes an inert tracer dye and a photocell analyzer monitoring the water and chemical solution, and wherein the chemistry treatment controller is configured to control the chemistry pump to blend the inert tracer dye with the reducing agent chemistry to control the chemistry application in a controlled process.

5. The system of claim 1, further comprising an oxidation reduction potential control sensor (ORP) monitoring the water and chemical solution, and wherein the chemistry treatment controller is configured to control the chemistry pump to apply the reducing agent chemistry in a controlled manner.

6. The system of claim 5, wherein the analyzer system comprises the chemistry treatment controller is responsive to the ORP sensor and configured to dose the reducing agent chemistry to maintain a certain concentration of the reducing agent chemistry in the recirculating path.

7. The system of claim 1, wherein the scrubber system includes a make-up water line to supply make-up water, a water meter on the make-up water line to measure the make-up water flow into the scrubber, and wherein the chemistry treatment controller is responsive to a water meter signal to determine a proportional signal to the chemical control pump to feed a ratio of the reducing agent to feed proportionally to make up water flow.

8. The system of claim 1, wherein the scrubber system includes a blow-down water line to remove scrubber water, a water meter on the blow-down water line to measure the blow-down water flow from the scrubber, and wherein the chemistry treatment controller is responsive to a water meter signal to determine a proportional signal to the chemistry pump to feed in relation to the blow-down of the scrubber.

9. The system of claim 1, wherein the reducing agent chemistry includes a tracer dye, the system further including an NO₂ sensor for measuring a level of NO₂ in the process gas stream to the scrubber system, a photocell analyzer that is configured to send ultraviolet light through scrubber water to directly measure the tracer dye, and wherein the chemistry treatment controller is responsive to the photocell analyzer to calculate the amount of chemical in the water, and to activate the chemistry pump based on a set point level predetermined in the chemistry treatment controller.

10. The system of claim 9, wherein the controller is configured to operate the chemistry pump based on a proportional integral derivative (PID) algorithm and setpoint to ensure that a correct amount of reducing agent chemistry is in the system based on a measurement of the NO₂ level in the incoming gas stream.

11. The system of claim 10, wherein the chemistry treatment controller is configured to use the input NO₂ signal level to calculate how much reducing agent chemistry is needed in the scrubber, and to adjust a pumping rate of the chemistry pump and dosage to ensure a precise amount of reducing agent chemistry is applied.

12. The system of claim 1, further comprising a non-oxidizing disinfecting chemical blended with the reducing agent chemistry.

13. The system of claim 1, wherein the system is configured to produce a chemical reaction of the reducing agent chemistry with dissolved elemental naturally occurring trace copper levels in treated scrubber water to a copper oxide compound available to react with carbon monoxide thus simultaneously reducing carbon monoxide levels in the process gas stream.

14. The system of claim 1, wherein the copper silver ionization equipment is further configured to treat microbiological contaminants in recirculation water while simultaneously producing available copper to react with the reducing agent chemistry to react and reduce carbon monoxide emissions.

15. The system of claim 14, wherein the scrubber system includes a make-up water line to supply make-up water, a water meter on the make-up water line to measure the make-up water flow into the scrubber, and wherein the chemistry treatment controller is responsive to a water meter signal to feed a proportional signal to the copper silver ionization equipment to proportionately feed copper and silver with the make-up water in a ratio basis.

16. The system of claim 1, wherein the reducing agent chemistry includes one or more of sodium thiosulfate, thiourea (99%), 2.4-pentanedione (99%), 2.3-pentanedione (97%), bar-bituric acid (99%), oxalic acid (98%), glyoxal (40 wt %), and di(ethline glocal) (99%).

17. A process configured to react an incoming process gas stream having phase nitrogen dioxide and carbon monoxide emissions from process applications in scrubber tower equipment with the use of reducing agent chemistry combined with copper silver ionization, comprising:
passing the process gas stream into a scrubber having a scrubber basin forming a water reservoir and a recirculating water path for passing water and scrubber chemistry from the basin over a scrubber packing material;
absorbing water soluble gases from the process gas stream into the water in the scrubber basin;
dispensing a reducing agent chemistry into the recirculation path; and
dispensing copper silver ionization treated water into the recirculation path.

18. The process of claim 17, wherein the reducing agent chemistry is ascorbic acid chemistry including one or more of sodium ascorbate/erythrobate, ammonium ascorbate/erythorbate, or mono-Dehydroascorbic acid used as a reducing agent to absorb nitrogen dioxide to reduce nitrogen-based emissions.

19. The process of claim 17, wherein the reducing agent chemistry includes one or more of sodium thiosulfate, thiourea (99%), 2.4-pentanedione (99%), 2.3-pentanedione (97%), bar-bituric acid (99%), oxalic acid (98%), glyoxal (40 wt %), and di(ethline glocal) (99%).
